(19) United States
(12) Patent Application Publication
(10) Pub. No.: US 2004/0062373 A1
(43) Pub. Date: Apr. 1, 2004

(54) Technique for invoking information assistance and services during a call

(76) Inventor: Nathan Bryant Baker, Tigard, OR (US)

Correspondence Address: Alex L. Yip, Kaye Scholer LLP, 425 Park Avenue, New York, NY, 10022, US

(21) Appl. No.: 10/313,712

(22) Filed: Dec. 6, 2002

Related U.S. Application Data
(60) Provisional application No. 60/414,965, filed on Sep. 30, 2002.

(51) Int. Cl. H04M 3/42

(52) U.S. Cl. 379/218.01

(57) ABSTRACT

A caller and a called party are connected via an information assistance call center. The call center monitors the connection for a signal such as a DTMF tone made by either party depressing the “0,” “#,” or “*” key. Once such a signal is detected, an operator joins the call and provides additional information assistance services to the parties. The call is routed via the information assistance call center, which is able to provide concierge-type services, such as making restaurant and movie reservations, and information management services, such as accessing call participants' profiles and folders containing, for example, call participants' preferences, appointment calendars, and contacts.

The present application claims under 35 U.S.C. 119(e) the benefit of U.S. Provisional Application No. 60/414,965 filed on Sep. 30, 2002.

### BACKGROUND OF THE INVENTION

The invention relates generally to a communications system and method. More specifically, the invention relates to a system and method for providing information assistance and services during a telephone call.

In a typical directory assistance call, a caller identifies to the operator the name and address (sometimes city or area code) of a party whose telephone number is desired. In response, the operator locates the desired destination telephone number using, e.g., a computer database. The destination number is then provided to the caller, e.g., by a computerized voice server which provides automated voicing of the number, and the caller is afforded an option to be connected to the destination number without the need of first terminating the directory assistance call.

Information assistance is an extension of directory assistance. In addition to connecting a caller to a destination number, information assistance operators can provide concierge-type services such as a restaurant guide and reservation service, event ticketing and reservation service, hotel reservation and availability service, travel or flight reservation and ticketing services, ordering specific items such as flowers or food delivery, arranging transportation, and accessing entertainment guides. The use of information assistance to provide such concierge-type services is disclosed, e.g., in commonly-assigned, co-pending U.S. application Ser. No. 09/520,306, “Technique for Providing Information Assistance Including Concierge-Type Services,” filed Mar. 7, 2000, incorporated herein by reference.

In addition, if a caller subscribes to an information assistance service, the caller may have one or more user profiles on file with the service that includes information pertaining to and about the caller, including his/her preferences. Such information may include a list of contacts (i.e., a personal phone directory), a schedule of appointments, to-do lists, notes, and personal preferences about such topics as restaurants, movies, sporting events, or hobbies. The caller may access the information assistance service in order to connect to a contact, retrieve an appointment or to-do list item, set up a new appointment or to-do list item, or request information about a restaurant, movie, or sporting event falling within the caller's personal preferences. The information assistance service may connect the caller to the contact or restaurant, or may make reservations at the restaurant or movie or sporting event as desired by the caller. The use of information assistance to provide these types of information management services is disclosed, e.g., in U.S. Pub. No. 2002/0055351 A1, published May 9, 2002, incorporated herein by reference.

### SUMMARY OF THE INVENTION

As disclosed in the prior art, these services may be invoked by a caller either prior to being connected to a destination number and possibly, in the case, for example, of a calendaring-type service, without even requesting to be connected with a destination number. The present invention improves on the prior art by allowing a caller to invoke these information assistance services during a telephone call, and having the information assistance operator join the call in order to perform or provide the requested service.

Thus, in accordance with the invention, when a call is received by an information assistance service provider, which includes an information service request, the provider obtains connection information responsive to the request, and causes a connection to be made from the caller to a destination party based on the connection information, thereby disconnecting the caller from the information assistance service provider. In addition, the connection between the caller and the destination party is monitored for a predetermined signal initiated by one of the caller and the destination party. The information assistance service provider joins the connection as a conferenced party upon detection of the predetermined signal to provide a selected information assistance service to at least one of the caller and the destination party.

The selected information assistance service may include, e.g., a directory assistance, concierge-type, or information management service. The concierge-type service may comprise retrieving information regarding establishments satisfying criteria specified by at least one of the parties to the call, making reservations, etc. The information management service may comprise managing an information source associated with at least one of the parties to the call, where the information source includes contacts and/or appointment information. The aforementioned predetermined signal may be a DTMF (dual-tone multi-frequency) signal generated by pressing a predetermined key on a telephone, or a voice command.

Advantageously, by routing the call through an information assistance service provider in accordance with the invention, the provider can readily be invoked during the call to effectively provide the aforementioned directory assistance, concierge-type and information management services, and access the call participants' user profiles containing user preferences for handling the call and provision of the services. Additional advantages of the invention will be set forth in the description which follows, and in part will be apparent from the description, or may be learned by practice of the invention. The advantages of the invention may be realized and obtained by means of the instrumentalities and combinations particularly pointed out in the appended claims.

### BRIEF DESCRIPTION OF THE DRAWINGS

The accompanying drawings, in which like reference numerals represent like parts, are incorporated in and constitute a part of the specification. The drawings illustrate presently preferred embodiments of the invention and, together with the general description given above and the detailed description given below, serve to explain the principles of the invention.

FIG. 1 illustrates a communications system including information/call centers in accordance with an embodiment of the present invention;

FIG. 2 illustrates a system for connecting an information assistance service call to a destination terminal in accordance with an embodiment of the present invention;

FIG. 3 illustrates an information assistance service provider and a servicing platform for providing an information assistance service;

FIG. 4 is a flowchart depicting a routine for joining a call to provide information assistance service in accordance with an embodiment of the present invention; and

FIGS. 5A and 5B illustrate a system for connecting an information assistance service call to a destination in accordance with another embodiment of the present invention.

### DETAILED DESCRIPTION

The present invention is directed to providing an information assistance service to call participants while they are engaged in a call. Such participants (or users) may be wireline (landline) telephone, wireless telephone, and other communications device (e.g., PDA) users. Such information assistance services include providing information management tools such as private directory, direct connect, calendaring, and user profile functions (collectively, “information management services”) and concierge-type services as described below. Such information management services can be flexibly defined by the users to effectively handle dynamic information. The latter may include, e.g., sales and price data which varies with time, and user profile preferences adjustable depending on different conditions, e.g., weekdays vs. weekends, daytime vs. evening, travel in business class vs. first class when one of the classes is full, and whether the user is in a roaming calling area. An expansive network of information/call centers is used where operators can effectively provide the users with the personalized information and communications services. Such services may include, e.g., providing directory information, movie listings, restaurant recommendations, directions to various places, etc.; making reservations; sending invitations; administering appointment calendars; ticketing; and conducting other transactions for the users. The term “operator” used herein broadly encompasses entities that are capable of providing information assistance in a telecommunications environment, including, without limitation, human operators, voice response/recognition capabilities, web-/WAP-enabled operator services, and other automated and electronic access.

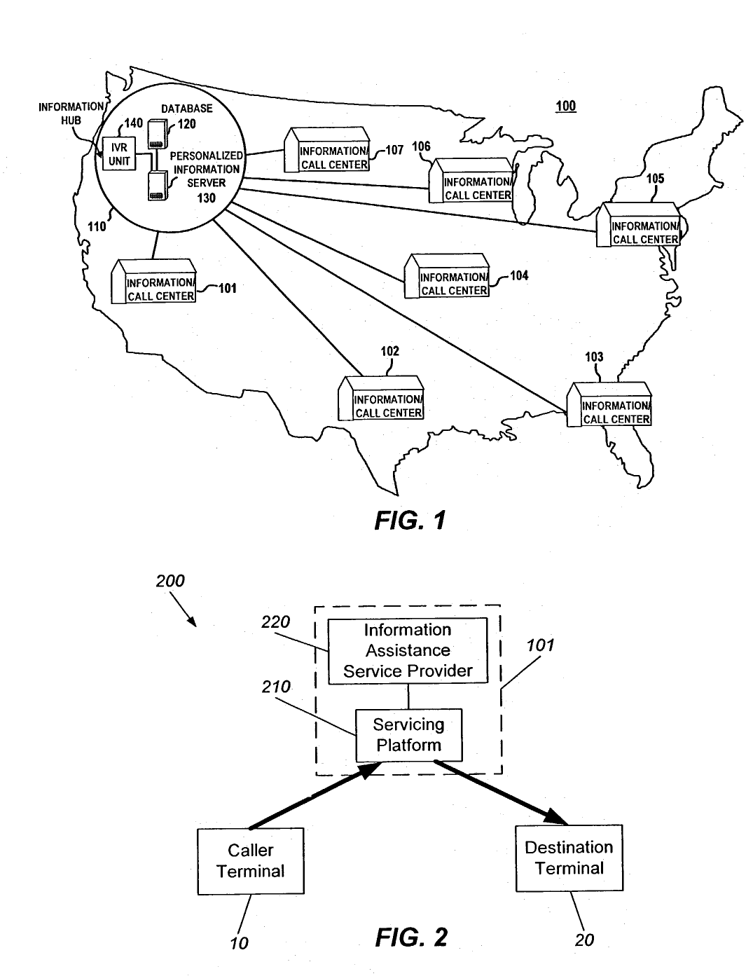

FIG. 1 illustrates a system embodying the principles of the invention, which includes wide area network (WAN) 100 covering an extensive area. WAN 100 can be an Internet-based network such as the World Wide Web or a private, intranet-based network. In this illustrative embodiment, WAN 100 connects operators dispersed throughout a wide coverage area in information/call centers 101-107. Each of information/call centers 101-107 covers one or more regional coverage areas. One or more information hubs 110 are also included in WAN 100. An information hub 110 includes one or more personalized information servers 130 which are accessible by the operators in the system and one or more databases 120 in which users' contacts, appointments, and other folders and information are stored and maintained. Information hub 110 may also include interactive voice response (IVR) unit 140 connected to server 130 for interacting with the user by voice, e.g., announcing to the user selected appointments. In addition to storing folders and information in information hub 110, they may also be stored locally at one or more of the information/call centers. The folders and information at different centers are synchronized. Synchronized databases provide necessary backup as well as support to roaming mobile device users. Other details regarding the contacts, appointments, and other folders and information stored in information hub 110 can be found in above-referenced U.S. Pub. No. 2002/0055351 A1. In particular, a contacts folder contains contact information, such as telephone, address, and e-mail, for people and/or organizations. A user may have separate contacts folders for different purposes, such as a personal contacts folder, a business contacts folder, a sports team contacts folder, etc. An appointment folder contains a user's appointment and/or calendar information, and may also have different appointments folders for different purposes. Other folders may include to-do lists, notes, e-mail, events, products, and other information that may be tailored to the needs of an individual or a group, e.g., a corporation, an organization, or a collection of people having a common interest. These folders are stored in database 120 and accessible by each information assistance operator through server 130. The user may have specific rights with respect to a folder, e.g., owner, administrator, read-only, etc. When the user accesses a folder through the operator, the operator becomes an alter ego of the user and is subject to the same rights as the user with respect to the folder. The user may create, maintain, or access a contacts, appointments, or other folder via the Internet or other communications means, or through an operator who in turn may create, maintain, or access the folder on behalf of the user. If using an operator, the user calls the operator at a designated access number, and the call is routed to information/call center 101 where an operator attends to the call. After the user communicates to the operator his/her needs, the operator accesses personalized information server 130 through WAN 100 (or alternatively via the Internet). In response, server 130 presents on the operator's terminal various graphical user interface (GUI) dialog boxes, e.g., “login” (for confirming the user's identity via User ID and password), “home” (listing the user's contacts, appointments, and other folders), “edit” (for editing specific folder contents), “view” (for viewing folder contents), for interacting with the operator.

FIG. 2 illustrates system 200 in which a caller initiates an information assistance call from caller terminal 10, which is routed to, say, information/call center 101 via one or more carrier switches in a carrier network, e.g., a public switched telephone network (PSTN), a wireless telephone network, etc. Information/call center 101 generically represents any of the aforementioned information/call centers 101-107 shown in FIG. 1. In this illustrative embodiment, users of a particular telephone carrier may dial, speak or otherwise communicate predetermined access digits, access codes or retail numbers, or input a predetermined address or URL (uniform resource locator) established by the carrier to access information/call center 101. For example, the predetermined access digits may be “411,” “*555,” “555-1212,” “00,” etc. Once connected to information/call center 101, the information/call center provides the caller with requested information including, e.g., a desired destination number. If the caller elects to have the information/call center complete the call to destination terminal 20 associated with the destination number, the call is routed to destination terminal 20 via one or more of the public (e.g., the PSTN) and private networks, switches, trunks, and central and end offices.

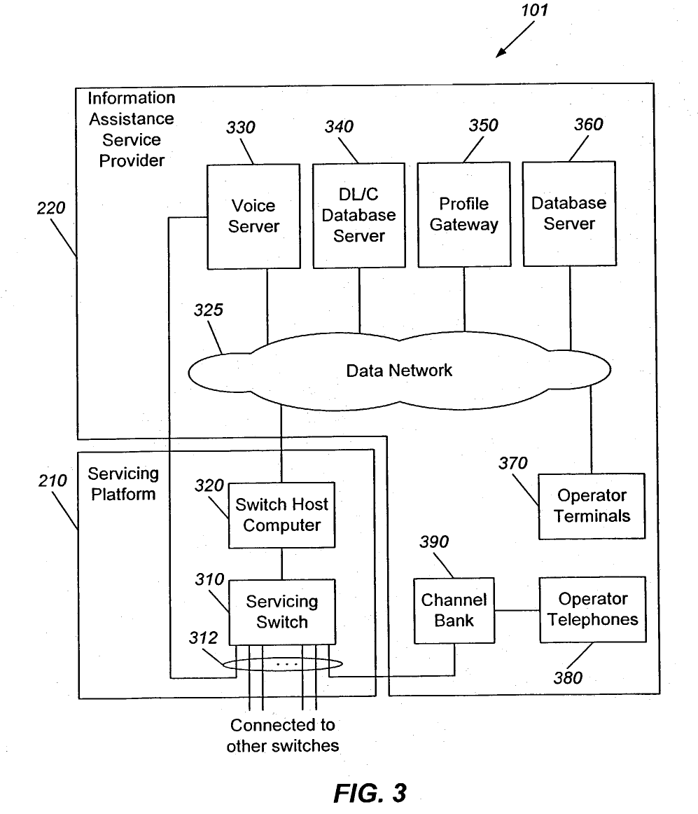

FIG. 3 illustrates information/call center 101, which may be configured to include information assistance service provider 220 together with servicing platform 210. It should be noted that even though both provider 220 and servicing platform 210 appear in the same figure, they may or may not be located in the same geographic area. Servicing platform 210 includes servicing switch 310 having Ti spans 312 for connection to voice server 330, channel bank 390, and one or more carrier networks. In an alternate embodiment, voice information may be packetized and transmitted pursuant to a VoIP (voice over IP (Internet Protocol)) protocol over a packet-switched network, e.g., the Internet, to information/call center 101. Servicing switch 310 may receive an incoming information assistance call from a carrier switch in a carrier network. Servicing switch 310 may also be used to place an outgoing call onto a carrier network, which may be different from the carrier network used for the incoming call.

Channel bank 390 in provider 220 is used to couple multiple operator telephones 380 to servicing switch 310. The operators in information/call center 101 are further equipped with operator terminals 370, each of which includes a video display unit and a keyboard with an associated dialing pad. Operator terminals 370 are connected over data network 325 to one or more database servers 360 (although only one is shown in the figure). Switch host computer 320 and voice server 330 are also connected to data network 325. By way of example, data network 325 includes a local area network (LAN) supplemented by a number of point-to-point data links. Through data network 325 and routers (not shown), components of information/call center 101 may also be connected to the Internet or other wide area networks (WANs).

Servicing switch 310 is conventional and supports digital T1 connectivity. The operation of servicing switch 310 is governed by instructions stored in switch host computer 320. In this illustrative embodiment, servicing switch 310 includes, among other things, arrays of digital signal processors (DSPs). These DSPs can be programmed and reprogrammed to function as, among other things, call progress analyzers (CPAs), call progress generators (CPGs), multi-frequency (MF) tone generators/detectors, voice recognizers dual-tone multi-frequency (DTMF) generators/detectors, or conference units, depending on the demand placed on information/call center 101 and servicing switch 310 for each corresponding function.

An incoming call requesting information assistance is received by servicing switch 310 in information/call center 101, which connects it to an available operator's telephone. If no operator is available when a call is received, the call is queued in a conventional manner until an operator becomes available. In this instance, automatic call distribution (ACD) logic of conventional design (not shown) is used to queue and distribute calls to operators in the order in which they are received, and such that the call traffic is distributed evenly among the operators. The ACD logic may reside in host computer 320 or elsewhere in information/call center 101. In other instances, other distribution logic schemes may be utilized, such as skills-based routing or a priority scheme for preferred users.

Operators may use database server 360 to provide information assistance including searching for a user's desired party and determining the appropriate destination number of the party. Other information assistance concerning restaurant recommendations, movie listings, events, etc. may also be provided by searching one or more of the internal and external databases, and the Internet.

Voice server 330 (also known as a “voice response unit” or “VRU”) is used to play the constant repeated parts of an operator's speech, namely, the various greetings and signoffs (or closings). Voice server 330 is connected via data network 325 to switch host computer 320 and via one or more T1 spans to servicing switch 310. Voice server 330 may comprise a general-purpose computer and one or more voice cards for voice recognition, voice recording and playback, and call progress analysis. At appropriate stages in a call progression, switch host computer 320 initiates a voice path connection between voice server 330 and servicing switch 310 such that the user, or the user and the operator, are able to hear whatever pre-recorded speech is played on that connection by voice server 330. Computer 320 then instructs voice server 330, via data network 325, what type of message to play, and passes data parameters that enable voice server 330 to locate the message appropriate to the call state.

Data network 325 may further connect to directory listing/concierge (DL/C) database server 340 and a profile gateway 350. DL/C database server 340 may contain directory listing information on restaurants, events, accommodations, transportation, travel information and booking, stock prices, weather, and other services such as grocery or flower delivery, etc. Together, DL/C database server 340 and database server 360 provide operators with the means to search for a caller's desired party and determine the appropriate telephone number. Preferably, these databases can search not only by name and address, but also by type of goods/services and/or geographical region, or by any other attribute in the caller record, including phone number. For example, DL/C database server 340 can answer queries soliciting the names/numbers of restaurants serving a desired cuisine on a given street.

Profile gateway 350 provides access to a user profile, which may include information about a subscriber to the information assistance service. Such information may include the subscriber's name, contact details (e.g., preferred phone number, fax number, and e-mail address), preferences (e.g., preferred restaurant and dining time, preferred mode of delivery of reservations), dietary requirements, likes and dislikes, past logged activities, etc. In a preferred embodiment, when the information assistance call is received by servicing switch 310 in information/call center 101, switch 310 derives, in a well-known manner, from the signaling associated with the call the caller's phone number from which the call originates, also known as an ANI (automatic number identification). Switch host computer 320 then requests via profile gateway 350 any profile identified by such an ANI. One embodiment of profile gateway 350 may include a data network interface, a communications interface, a processor, and memory. Profile data may be input and updated (e.g., via Internet web pages or operator) through a profile manager (not shown) located, e.g., in information hub 110 in FIG. 1. Copies of the profile data are distributed to the profile gateways in various information/call centers through WAN 100. In response to a request for a profile, the processor in the profile gateway searches the memory (which may include disks, caches, and volatile and nonvolatile memories) for the profile identified by the ANI. If a profile is available, the profile data are served to switch host computer 320, and database servers 340 and 360. When the operator answers the call, server 360 communicates to the operator through terminal 370 any profile data pertinent to the handling of the call. The operator then interacts with the caller and uses server 360 to locate the requested listing. Once a listing is located, the relevant user preferences from the profile automatically populate the fields in an electronic request, e.g., for a restaurant reservation, on operator terminal 370, thereby reducing the need for interrogation by the operator.

The caller may be afforded an option to be connected through information/call center 101 to destination terminal 20 based on the connection information (e.g., destination telephone number) in the requested listing. In accordance with the invention, either party to the call (i.e., caller or destination party) can invoke further information assistance services by an operator in information/call center 101 such as directory assistance, concierge-type, or information management services. This may occur, for example, if the parties, while talking on the phone, decide to go out to dinner or a movie. Either party may invoke further information assistance services, and the operator would join the call through servicing switch 310 as a conferenced party in a 3-way conference call. Either party could then request the operator to find an appropriate restaurant or movie based on criteria supplied by the calling parties. For example, the caller or the destination party may request listing information, e.g., regarding all vegetarian restaurants in a particular area, or requests a reservation at, say, a favorite restaurant. The operator obtains, from a user profile of the requesting party associated with his/her telephone number (ANI for the caller, and the destination telephone number for the destination party), dietary preferences, desired restaurant location, type of credit card to be used, restaurant views, etc. The operator then searches a database (340 and/or 360) for listing information to produce a desired output such as a list of vegetarian restaurants satisfying his/her personal preferences and request. Once the restaurants are identified, the operator announces the search results to the parties on the conference call. After the parties agree on a desired restaurant, the operator may offer to make the restaurant reservation for the parties. To that end, the operator may elicit from the parties the preferred dining time and number of dining parties. The methodology used by an information assistance service to make such reservations is disclosed, e.g., in commonly assigned copending application Ser. No. 10/201,236, filed Jul. 22, 2002, hereby incorporated by reference. Based on the disclosed methodology, the operator may make the reservation in real time or off-line.

Invocation of further information assistance services may also occur if, for example, the parties want to schedule a meeting for sometime later, and one or both of the parties subscribe to the aforementioned information management service which maintains contacts and appointment folders for the party(ies). Again, invoking such further information assistance services would cause the operator to join the call as a conferenced party. The party or parties who subscribe to the management service then request the operator to set up an appointment using the appropriate appointment folder of the party's, which is maintained in database 120. Invocation of further information assistance services can occur by either of the parties pressing a key (such as “0,” “#,” or “*”) or voicing a command (e.g., uttering “operator”) while information/call center 101 monitors the connection for such a keystroke or voice command (i.e., a predetermined signal).

Use of a keystroke to invoke an operator is reminiscent of the StarBack® feature as disclosed in several patents assigned to the assignee of this invention, e.g., U.S. Pat. No. 5,797,092, issued to Cox et al. and hereby incorporated by reference. Those patents, however, disclose that use of such a keystroke to invoke the operator is limited to the calling party when there is no current connection to the called party, because, for example, the called party is busy or unavailable (busy or ring/no-answer response) or the called party has hung up (see, e.g., U.S. Pat. No. 5,797,092, col. 7, 11. 1-5: “the caller can perform a tone signal triggered, return transfer . . . simply by pressing the ‘*’ (star) key on the caller's telephone once or twice”).

The invocation of an operator by either party using a keystroke is also different from that disclosed in U.S. Pat. No. 5,414,754, issued to Pugh et al., which describes transferring to a live operator by pressing “0.” That patent also discloses that it is the caller who invokes the operator service using the keystroke (see, e.g., col. 11, 11. 39-53: “[c]allers can elect to be transferred to a live operator”; “the caller can choose” from “a list of enhanced services options”). Furthermore, the invocation of the operator in that patent differs from the present invention in that the caller in that patent does not connect to the called party through an information/call center or information/assistance service initially.

Thus, in accordance with the invention, after invoking further information assistance services during the on-going phone conversation between the caller and the destination party, the operator may join as an additional conferenced party. In this way, each of the parties can hear and talk to any of the other parties. Either the caller or destination party can then, for example, request from the operator to look for information concerning a restaurant or a movie satisfying certain criteria presented to the operator, and request the operator to make a reservation, as described before. In addition, assuming in this example that each of the caller and destination party is a subscriber of the aforementioned information management service, the operator can set up a meeting or teleconference based on an appointment schedule found in the parties' appointment folders stored in database 120. To do so, the operator accesses each party's information management service, and verifies the login information for each party. The information management service may be accessed using userIDs, which may be the telephone numbers under which the subscribers have accounts, and passwords received from the subscribers. For the caller's information management service, the userID may conveniently be the ANI which is derived by servicing switch 310 from the call set-up signals associated with the caller's initial information assistance call received by switch 310. For the destination party's information management service, the userID is identified by the destination telephone number previously looked up by the operator for the caller in the initial information assistance call. Such ANI and destination telephone number are maintained, e.g., in computer 320 until both the caller and destination party terminate the connection. Once the userIDs are determined, the operator may request from each party his/her password, and initiates a signal to operate a well known capability in switch 310 to mute the connection to the other party to prevent such other party from hearing the password. Alternatively, each party may use DTMF tones to enter the password, which are detectable using the aforementioned DSPs in switch 310.

It should be noted at this point that after the operator joins the call, in accordance with an aspect of the invention the caller can exercise different options by voice commands or by pressing predetermined keys on his/her telephone (DTMF tones), respectively. For example, a first option may be allowing the caller to control the destination party's ability to hear any conversation between the caller and the operator. To that end, a DSP in switch 310 is programmed to monitor for a first DTMF tone (voice command) initiated by the caller to exercise the first option. Upon detection of one such DTMF tone, the DSP operates a well known capability in switch 310 to mute the connection to the destination party, thereby allowing a private conversation between the caller and the operator. A second option may be allowing the caller to disconnect the destination party from the call so that the caller can have an exclusive conversation with the operator. To that end, a DSP in switch 310 is programmed to monitor for a second DTMF tone (voice command) initiated by the caller to exercise the second option. Upon detection of one such DTMF tone, the DSP operates a well known capability in switch 310 to disconnect the destination party from the call, thereby allowing an exclusive conversation between the caller and the operator.

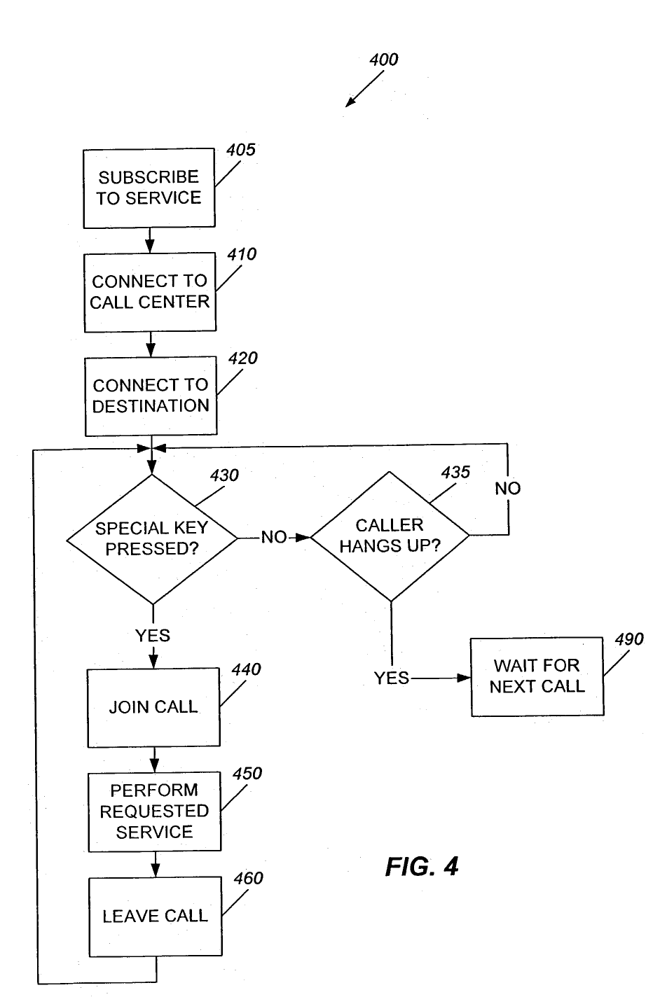

FIG. 4 illustrates routine 400 for joining a call by an operator to provide information assistance service in accordance with an embodiment of the present invention. In step 405, a caller initially subscribes to the information assistance service. During this subscription, or at some time later, the caller may set up a user profile of contact details and preferences for use with the various information services offered by the information/call centers. At the time of subscription, or at any time later, the caller initiates a call from caller terminal 10 by connecting to information/call center 101 as indicated by step 410. The caller may request the operator to connect to someone within the caller's personal directory (or contacts folder) or may use the operator as a directory assistance service to look up the number of someone not in the caller's personal directory (for example, a business or a new client). Once the desired number is located, the operator attempts to connect caller terminal 10 to destination terminal 20. If there is a busy signal or a ring/no-answer response, the caller may attempt to connect to another destination by invoking the operator in accordance with the StarBack technique described above. However, once caller terminal 10 and the called party are connected in step 420, the operator disconnects (without releasing the link), and information/call center 101 in step 430 monitors the connection for the depressing of a special key (e.g., “0,” “#,” or “*”) or other signal. Such monitoring may be performed by servicing switch 310 in information/call center 101. If the special key is not depressed in step 430, information/call center 101 in step 435 monitors whether the caller has hung up (gone on-hook). If the caller has hung up, the information/call center releases its link to caller terminal 10 and waits for the next call in step 490. If the caller has not yet hung up in step 435, the process loops to step 430.

If, in step 430, information/call center 101 detects that the special key is depressed by either party to the call, servicing switch 310 conferences in the operator to join the call in step 440. In step 450, the operator performs the requested information assistance, concierge-type, or information management service, and, when finished, in step 460 leaves the call. The parties to the call continue the call as before and the routine loops back to steps 430 and 435 to continue monitoring for depression of the special key or for the caller to hang up.

It should be noted that the invention is not limited to a call made from caller terminal 10 to a single called party, but can include a conference call in which the connections to the called parties are made via information/call center 101. Such connections may be initiated serially by the caller (i.e., the caller asks to connect to called party 1, then called party 2, etc.), or the caller and the called parties may dial in to a central information/call center number. Then, once engaged in the conference call, any party to the call may invoke the operator by depressing the special key. Note that such an embodiment differs from conventional conference calling features in that invocation of the operator in that situation is merely to enable the operator to assist with the technicalities of the conference call (e.g., correct a connection problem, add ports for more called parties, etc.). None of those conventional conference calling environments offers directory assistance, concierge-type, and information management services to the caller and called parties as is done in the present invention.

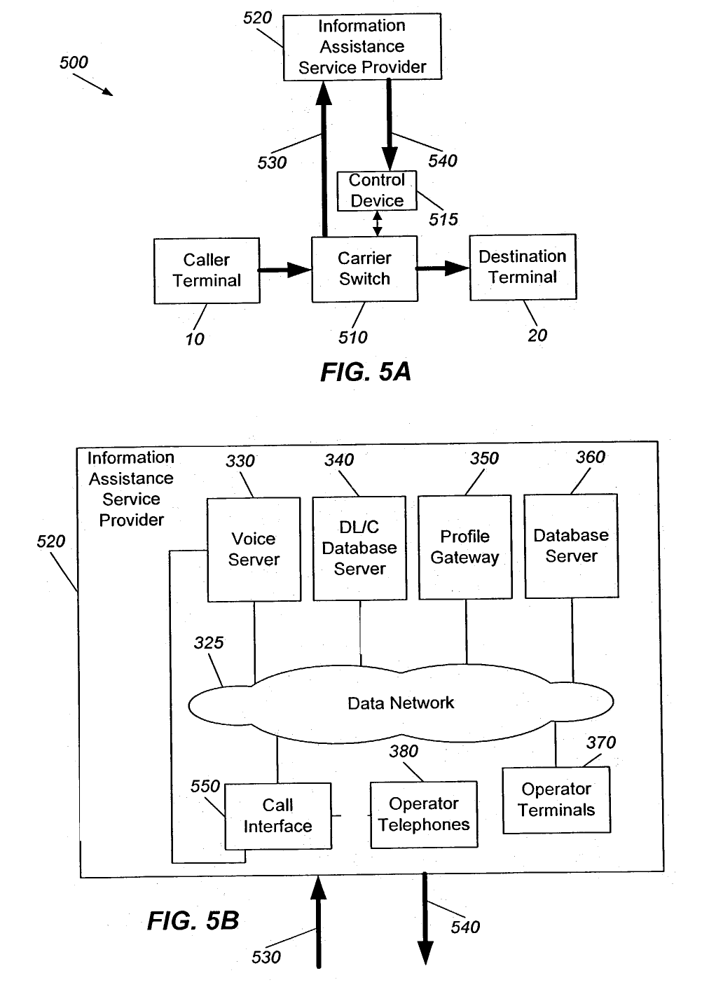

Instead of using the system as shown in FIG. 2, the present invention may use another system 500 for providing information assistance as shown in FIG. 5A. In system 500, the information call/center does not have its own servicing platform and servicing switch as in FIG. 2. Instead, system 500 receives the information assistance request from a carrier switch 510 (via a control device 515) and transmits the appropriate response to control device 515. Thus, the caller initiates an information assistance call from caller terminal 10 by pressing, e.g., “411” or “555-1212,” etc. Control device 515 looks up the Direct Inward Dial (DID) number directed to information assistance service provider 520 and connects caller terminal 10 to information assistance service provider 520. The voice request for information assistance is routed to information assistance service provider 520 via DID connection 530, e.g., using the PSTN, a wireless telephone network, etc. (In this embodiment, there is not always a direct trunk line to information assistance service provider 520 from the carrier switch.) FIG. 5B illustrates information assistance service provider 520, which is similar to information assistance service provider 220, but does not have access to its own servicing platform 210. The voice request is received by call interface 550, which may include the aforementioned ACD logic for distributing the call to the next available operator's telephone 380. Using the available databases, the operator determines the destination telephone number and provides to control device 515 the requested information in data form via data link 540, e.g., an Internet connection. Using the information from information assistance service provider 520, carrier switch 510 then completes the call to destination terminal 20 via a combination of public (e.g., the PSTN) and private networks, switches, trunks, and central and end offices. One benefit of using system 500 is that information assistance service provider 520 can be implemented more simply than information assistance service provider 220 because the former does not require a switch separate from the carrier switch.

In using the system of FIG. 5A, flowchart 400 is modified accordingly. In step 410, the caller is connected via DID connection 530 to information assistance service provider 520, which determines the requested destination telephone number and transmits the number via Internet connection 540 to control device 515. Control device 515 connects the caller to destination terminal 20 in step 420. In step 430, monitoring for depression of the special key in step 430 can be performed by either control device 515 or carrier switch 510. If the special key is pressed by either call party, control device 515 calls information assistance service provider 520 over DID connection 530, and the operator is conferenced in via carrier switch 510 as indicated by step 440. In step 450, the operator performs the requested information assistance, concierge-type, or information management service, and, when finished, in step 460 leaves the call and drops the connection to carrier switch 510. The parties to the call continue the call as before and the routine loops back to steps 430 and 435 to continue monitoring for depression of the special key or for the caller to hang up.

The present invention also includes using the information/call center to route calls serviced by an operator, such as collect calls, station-to-station calls, person-to-person calls, and calls billed to a third-party. In addition, the present invention includes using telecommunications relay stations to route calls. Such stations are used to assist hearing-impaired customers to use telecommunications services. These stations perform speech-to-text and text-to-speech conversion. In the context of the present invention, once the caller is connected to a called party or parties using a telecommunications relay station, any of the parties can invoke the operator to join the connection and communicate with any party in the appropriate manner.

As discussed above, additional advantages and modifications will readily occur to those skilled in the art. Therefore, the present invention in its broader aspects is not limited to the specific embodiments, details, and representative devices shown and described herein. Accordingly, various changes, substitutions, and alterations may be made to such embodiments without departing from the spirit or scope of the general inventive concept as defined by the appended claims.

In addition, the invention equally applies regardless of whether feature group D (FGD) type signaling, SS7 out-of-band signaling or other signaling is used for communications between carrier switches and switch 310 of FIG. 2.

In addition, information/call center 101 and information assistance service provider 520 are disclosed herein in a form in which various functions are performed by discrete functional blocks. However, any one or more of these functions could equally well be embodied in an arrangement in which the functions of any one or more of those blocks or, indeed, all of the functions thereof are realized, for example, by one or more appropriately programmed processors.

What is claimed is:

1. A method for providing an information assistance service, comprising:
receiving, by an information assistance service provider, a call from a caller, the call including an information service request;
obtaining connection information responsive to the information service request;
disconnecting the caller from the information assistance service provider and connecting the caller to a destination party based on the connection information;
monitoring a connection between the caller and the destination party for a predetermined signal initiated by one of the caller and the destination party; and
joining the connection by the information assistance service provider upon detection of the predetermined signal to provide a selected information assistance service to at least one of the caller and the destination party.

2. The method according to claim 1, wherein the connection information includes a telephone number.

3. The method according to claim 1, further comprising searching at least one database for the connection information.

4. The method according to claim 1, wherein the predetermined signal includes a DTMF signal.

5. The method according to claim 1, wherein the predetermined signal includes a voice command.

6. The method according to claim 1, wherein the selected information assistance service includes a concierge-type service for providing information concerning a supplier of desired goods or service.

7. The method according to claim 6, wherein the concierge-type service includes making a reservation with the supplier.

8. The method according to claim 1, wherein the selected information assistance service includes an information management service for managing one or more information sources associated with at least one of the caller and the destination party.

9. The method according to claim 8, wherein the one or more information sources include contacts information.

10. The method according to claim 8, wherein the one or more information sources include appointment information.

11. The method according to claim 1, wherein the selected information assistance service is provided in accordance with preferences associated with the caller.

12. The method according to claim 1, wherein the selected information assistance service is provided in accordance with preferences associated with the destination party.

13. The method according to claim 1, wherein the information assistance service provider includes an operator.

14. The method according to claim 1, wherein the information assistance service provider includes a voice server.

15. The method according to claim 1, further comprising muting a connection to the destination party upon detection of a second predetermined signal.

16. The method according to claim 15, wherein the second predetermined signal is initiated by the information assistance service provider.

17. The method according to claim 15, wherein the second predetermined signal is initiated by the caller.

18. The method according to claim 1, further comprising disconnecting the destination party from the connection upon detection of a second predetermined signal initiated by the caller.

19. A method for providing an information assistance service comprising:
receiving a call from a caller, the call including an information service request;
obtaining first connection information responsive to the information service request;
connecting the caller to a destination party based on the first connection information;
monitoring a connection between the caller and the destination party for at least a predetermined signal initiated by the destination party; and
joining the connection to provide a selected information assistance service upon detection of the predetermined signal, the selected information assistance service being provided based on second connection information.

20. The method according to claim 19, wherein the connection is also monitored for a predetermined signal initiated by the caller.

21. The method according to claim 19, wherein the second connection information includes the first connection information.

22. The method according to claim 19, wherein the second connection information includes an automatic number identification (ANI) associated with the caller.

23. The method according to claim 19, wherein the first connection information includes a telephone number.

24. The method according to claim 19, wherein the second connection information includes a telephone number.

25. The method according to claim 19, wherein the predetermined signal includes a DTMF signal.

26. The method according to claim 19, wherein the predetermined signal includes a voice command.

27. The method according to claim 19, wherein the selected information assistance service includes a concierge-type service for providing information concerning a supplier of desired goods or service.

28. The method according to claim 27, wherein the concierge-type service includes marking a reservation with the supplier.

29. The method according to claim 19, wherein the selected information assistance service includes an information management service for managing one or more information sources associated with at least one of the caller and the destination party.

30. The method according to claim 29, wherein the one or more information sources include contacts information.

31. The method according to claim 29, wherein the one or more information sources include appointment information.

32. The method according to claim 19, wherein the selected information assistance service is provided in accordance with preferences associated with the caller.

33. The method according to claim 19, wherein the selected information assistance service is provided in accordance with preferences associated with the destination party.

34. The method according to claim 19, further comprising muting a connection to the destination party upon detection of a second predetermined signal.

35. The method according to claim 34, wherein the second predetermined signal is initiated by the information assistance service provider.

36. The method according to claim 34, wherein the second predetermined signal is initiated by the caller.

37. The method according to claim 19, further comprising disconnecting the destination party from the connection upon detection of a second predetermined signal initiated by the caller.

38. A system for providing an information assistance service, comprising:
an interface for receiving, by an information assistance service provider, a call from a caller, the call including an information service request;
at least one database for obtaining therefrom connection information responsive to the information service request;
a mechanism for disconnecting the caller from the information assistance service provider and connecting the caller to a destination party based on the connection information; and
a processor for monitoring a connection between the caller and the destination party for a predetermined signal initiated by one of the caller and the destination party; the information service provider joining the connection upon detection of the predetermined signal to provide a selected information assistance service to at least one of the caller and the destination party.

39. The system according to claim 38, wherein the connection information includes a telephone number.

40. The system according to claim 38, wherein the predetermined signal includes a DTMF signal.

41. The system according to claim 38, wherein the predetermined signal includes a voice command.

42. The system according to claim 38, wherein the selected information assistance service includes a concierge-type service for providing information concerning a supplier of desired goods or service.

43. The system according to claim 42, wherein the concierge-type service includes making a reservation with the supplier.

44. The system according to claim 38, wherein the selected information assistance service includes an information management service for managing one or more information sources associated with at least one of the caller and the destination party.

45. The system according to claim 44, wherein the one or more information sources include contacts information.

46. The system according to claim 44, wherein the one or more information sources include appointment information.

47. The system according to claim 38, wherein the selected information assistance service is provided in accordance with preferences associated with the caller.

48. The system according to claim 38, wherein the selected information assistance service is provided in accordance with preferences associated with the destination party.

49. The system according to claim 38, wherein the information assistance service provider includes an operator.

50. The system according to claim 38, wherein the information assistance service provider includes a voice server.

51. The system according to claim 38, further comprising a device for muting a connection to the destination party upon detection of a second predetermined signal.

52. The system according to claim 51, wherein the second predetermined signal is initiated by the information assistance service provider.

53. The system according to claim 51, wherein the second predetermined signal is initiated by the caller.

54. The system according to claim 38, further comprising a device for disconnecting the destination party from the connection upon detection of a second predetermined signal initiated by the caller.

55. A system for providing an information assistance service comprising:
an interface for receiving a call from a caller, the call including an information service request;
at least one database for obtaining therefrom first connection information responsive to the information service request;
a mechanism for connecting the caller to a destination party based on the first connection information; and
a processor for monitoring a connection between the caller and the destination party for at least a predetermined signal initiated by the destination party; an information assistance service provider joining the connection to provide a selected information assistance service upon detection of the predetermined signal, the selected information assistance service being provided based on second connection information.

56. The system according to claim 55, wherein the connection is also monitored for a predetermined signal initiated by the caller.

57. The system according to claim 55, wherein the second connection information includes the first connection information.

58. The system according to claim 55, wherein the second connection information includes an ANI associated with the caller.

59. The system according to claim 55, wherein the first connection information includes a telephone number.

60. The system according to claim 55, wherein the second connection information includes a telephone number.

61. The system according to claim 55, wherein the predetermined signal includes a DTMF signal.

62. The system according to claim 55, wherein the predetermined signal includes a voice command.

63. The system according to claim 55, wherein the selected information assistance service includes a concierge-type service for providing information concerning a supplier of desired goods or service.

64. The system according to claim 63, wherein the concierge-type service includes marking a reservation with the supplier.

65. The system according to claim 55, wherein the selected information assistance service includes an information management service for managing one or more information sources associated with at least one of the caller and the destination party.

66. The system according to claim 65, wherein the one or more information sources include contacts information.

67. The system according to claim 65, wherein the one or more information sources include appointment information.

68. The system according to claim 55, wherein the selected information assistance service is provided in accordance with preferences associated with the caller.

69. The system according to claim 55, wherein the selected information assistance service is provided in accordance with preferences associated with the destination party.

70. The system according to claim 55, wherein the information assistance service provider includes an operator.

71. The system according to claim 55, wherein the information assistance service provider includes a voice server.

72. The system according to claim 55, further comprising a device for muting a connection to the destination party upon detection of a second predetermined signal.

73. The system according to claim 72, wherein the second predetermined signal is initiated by the information assistance service provider.

74. The system according to claim 72, wherein the second predetermined signal is initiated by the caller.

75. The system according to claim 55, further comprising a device for disconnecting the destination party from the connection upon detection of a second predetermined signal initiated by the caller.
